(19) United States
(12) Patent Application Publication
(10) Pub. No.: US 2015/0318082 A1
(43) Pub. Date: Nov. 5, 2015

(54) Signal and Drain Arrangement for High Speed Cables

(71) Applicant: Dell Products L.P., Round Rock, TX (US)

(72) Inventors: Sandor Farkas, Round Rock, TX (US); Bhyrav M. Mutnury, Round Rock, TX (US); Xinyun Guo, Rolla, MO (US)

(73) Assignee: Dell Products L.P., Round Rock, TX (US)

(21) Appl. No.: 14/265,556

(22) Filed: Apr. 30, 2014

(51) Int. Cl. H01B 11/10

(52) U.S. Cl. CPC H01B 11/10; H01B 11/1091

(57) ABSTRACT

A system and method are disclosed for a novel dual axial cable configuration. More specifically, with a dual axial cable configuration in accordance with the present invention, a shape of the signal conductors and drain conductors is configured to ensure the electric field density is oriented towards the drain conductor. More specifically, in certain embodiments, the dual axial cable configuration comprises signal conductors and a drain conductor in which either or all the cross sectional shapes of the signal conductors and the drain conductor are rectangular. Such a dual axial cable configuration results in thinner insulation lowering the cable height and also reduces space by improving the pitch of the conductors when the conductors are stored in bulk. Additionally, in certain embodiments, the signal conductors are positioned horizontally and vertically equidistant. The signal conductors are also positioned equidistant from a horizontally centrally positioned and vertically offset drain conductor.

### BACKGROUND OF THE INVENTION

1. Field of the Invention

The present invention relates to the management of information handling systems. More specifically, embodiments of the invention relate to a signal and drain arrangement for use with high speed cables that in certain embodiments are used with information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to couple components within and among information handling systems using high speed cables. Cables often provide a lower loss mode for signal propagation compared to printed circuit boards (P(Bs). For cost reasons, many cable standards use a copper cable implementation for their differential signaling. Shielded dual axial differential pair type cables are commonly used for short to medium reach (e.g., less than 10-20 meter connection distances). A plurality of cable standards such as Serial Attached SCSI (SAS), InfiniBand, SATA, PCI-Express, Double Speed Fibre Channel, Synchronous Optical. Networking/Synchronous Digital Hierarchy (SONET/SDH) high speed copper, and 10 Gbps, 25 Gbps, 40 Gbps and 100 Gbps Ethernet specify dual axial differential pair type cables. A cross section of an example dual axial differential pair type cable is shown in FIG. 1, labeled Prior Art. In many dual axial shielded differential pair type cable, a shield is wrapped around conductor pairs. However, many of these types of cables can present a bandstop filter or resonance characteristic (also sometimes referred to as a ‘suckout’) that can limit the performance of the cable. In the example dual axial differential pair type cable shown in FIG. 1, a two dimensional representation of an electric field distribution is shown where the shield wrap overlap of the cable can act as an impedance discontinuity. More specifically, as can be seen from the electric field distribution shown in FIG. 1, the current return is the strongest on the sides of the conductors (closest to the shield) and weakest around the drain wire. Hence, the drain wire in the dual axial construction does not mitigate the discontinuity due to its position relative to the signal conductors, For example, FIG. 2, labeled Prior Art, shows a graph of a resonance effect for a 28 America Wire Gauge (AWG) dual axial cable.

A number of approaches have been developed to address the issues associated with shielded dual axial differential pair type cables. For example, certain cables are provided with a uniform shield around the cable. However such a configuration can add significant cost and complexity to the manufacturing of the cable. Alternately, certain cables are provided with two drain wires which are positioned on both sides of the differential pair conductors. Such a configuration of often referred to as a dual-drain dual axial type cable. FIG. 3, labeled Prior Art, shows a cross section of an example of a dual-drain axial type cable However, a dual-drain axial type cable can also have certain issues. For example, such a configuration increases the width of the cables. The increased width can be problematic in certain information handling system designs where mechanical constraints make it difficult to use a cable that is too stiff or too wide. Sometimes when these mechanical constraints are present, a cable may be designed which uses a higher American wire gauge (AWG); however this type of design can increase the cable losses. Another issue is presented because adjacent differential pairs in the ribbon cable will have two drain wires side by side. However, because certain board designs have a single ground (GND) pad for isolating differential pairs, soldering two drain wires to a single GND pad in one hot-bar operation can requires manual wire alignment.

### SUMMARY OF THE INVENTION

A system and method are disclosed for a novel dual axial cable configuration. More specifically, with a dual axial cable configuration in accordance with the present invention, a shape of the signal conductors and drain conductors is configured to ensure the electric field density is oriented towards the drain conductor. More specifically, in certain embodiments, the dual axial cable configuration comprises signal conductors and a drain conductor in which either or all the cross sectional shapes of the signal conductors and the drain conductor are rectangular. Such a dual axial cable configuration results in thinner insulation lowering the cable height. Such a dual axial cable configuration also reduces space by improving the pitch of the conductors when the conductors are stored in bulk. Additionally, in certain embodiments, the signal conductors are positioned horizontally and vertically equidistant. The signal conductors are also positioned equidistant from a horizontally centrally positioned and vertically offset drain conductor. By so positioning the signal conductors and the drain conductor, a high density current path is concentrated on the drain conductor so as to reduce high density current passing through the shield. This will concentrate the fields on the drain conductor making a single middle drain conductor effective.

Additionally, in certain embodiments, the dual axial cable configuration further comprises signal conductors and a drain conductor in which either or all the cross sectional shape of the signal conductors and the drain conductor comprise a rotationally invariant shape such as a star shape. Such a dual axial cable configuration also increases the electrical performance of the cable. The cable configuration provides better characteristic impedance (also referred to as surge impedance or SI) performance. Such a cable configuration is also thinner and more flexible than known dual axial cable designs. Such a cable configuration also shifts resonances within the dual axial cable.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled Prior Art, shows a cross-section of an example dual axial cable.

FIG. 2, labeled Prior Art, shows a graph of an example resonance effect of a dual axial cable.

FIG. 3, labeled Prior Art, shows a cross-section of an example dual drain dual axial cable.

FIG. 4 shows a block diagram of components of an information handling system as implemented in the system and method of the present invention.

FIG. 5 shows a cross-section of a dual axial cable in accordance with the present invention.

FIG. 6 shows a graph of an example resonance shift due to a dual axial cable in accordance with the present invention.

FIG. 7 shows examples of conductor orientations in a dual axial cable in accordance with the present invention.

FIG. 8 shows example eye plots comparing a known dual axial cable with a dual axial cable in accordance with the present invention.

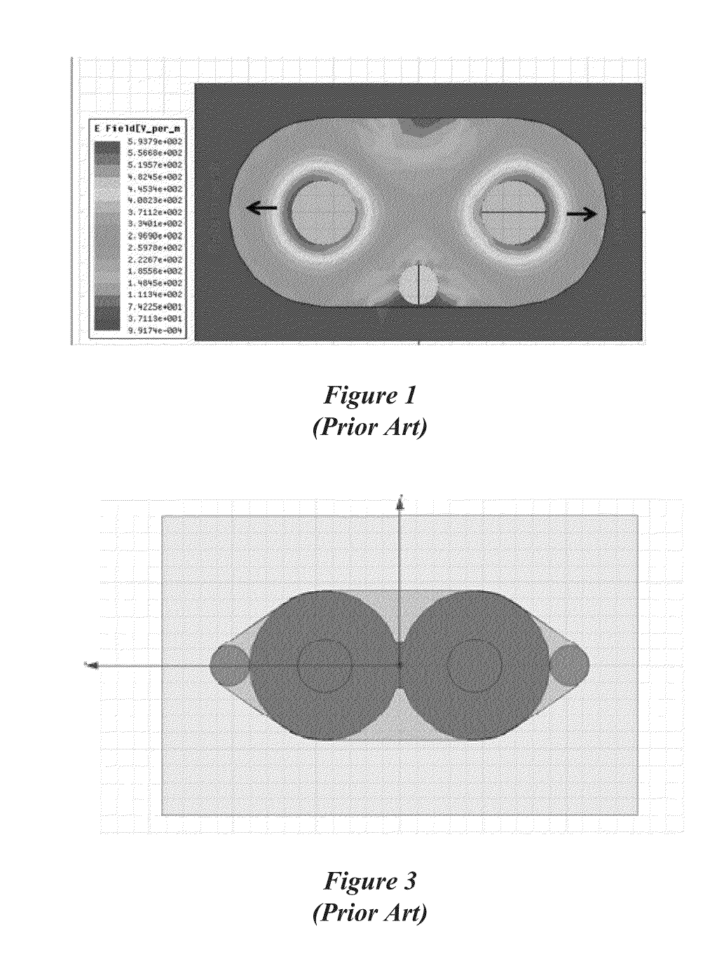

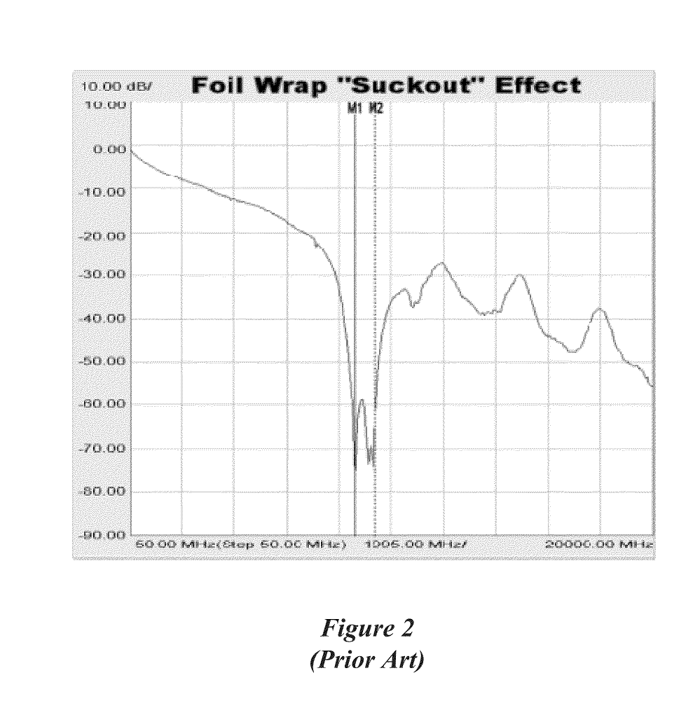

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

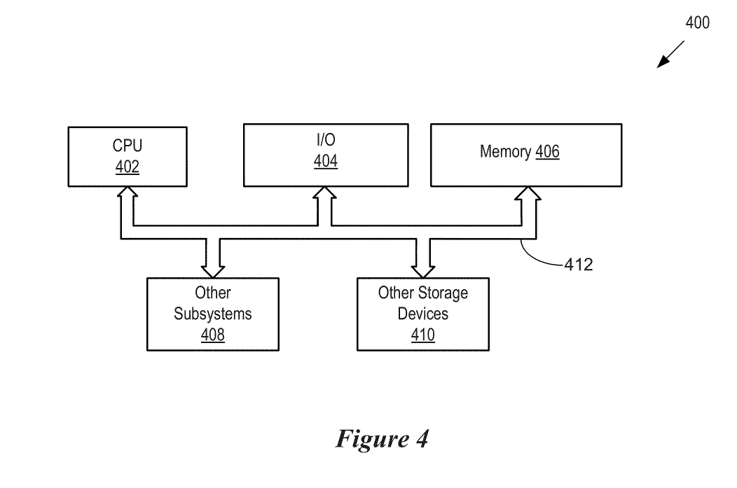

FIG. 4 is a generalized illustration of an information handling system 400 that can be used to implement the system and method of the present invention. The information handling system 400 includes a processor (e.g., central processor unit or “CPU”) 402, input/output (I/O) devices 404, such as a display, a keyboard, a mouse, and associated controllers, memory 406, and various other subsystems 408. The information handling system 400 likewise includes other storage devices 410. The components of the information handling system are interconnected via one or more buses 412. Some or all of the components of the information handling system 100 are interconnected via a cable in accordance with the present invention.

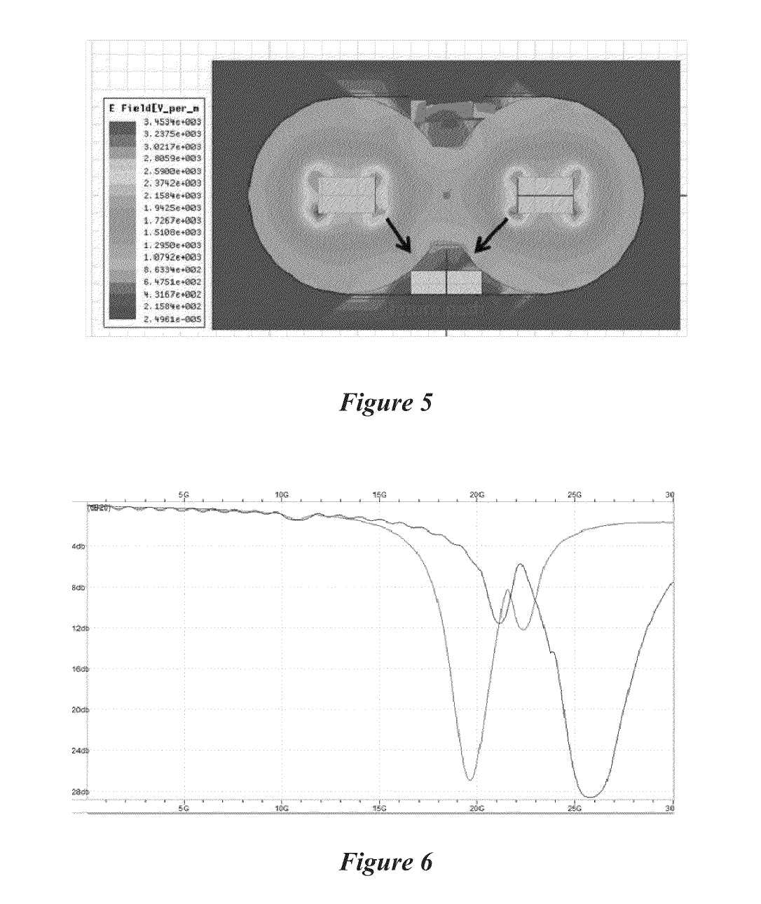

Referring to FIG. 5, a cross-section of a dual axial cable 500 in accordance with the present invention is shown. More specifically, in the dual axial cable 500, the shape of some or all of the signal conductors 510, 512 and the drain conductor 514 is substantially rectangular (as compared with the spherical shape of known conductors) (e.g., +/−10 degrees of perpendicular). In certain embodiments all parallelogram shaped conductors are considered substantially rectangular. In certain embodiments, some or all of the signal conductors and the drain conductor are square. Providing conductors which are substantially rectangular improves the electrical field density distribution around the conductors. The width and length of the conductors in the dual axial cable 500 are of substantially similar dimension (e.g., +/−25 percent along one or both of the width and length) when compared with a corresponding spherical AWG diameter. Thus, if a spherical dual axial cable included 28 AWG conductors each or both of the width and length of the conductors in a similarly sized dual axial cable 500 would be +/−0.0126 inches.

As can be seen from the electric field distribution, providing a dual axial cable with signal conductors as shown, the electric fields are oriented between the signal conductors thus providing a drain conductor zone (i.e., the area around the drain conductor) as a strong current zone. Thus, the field density in this drain conductor zone is stronger (in certain embodiments the increased strength of the field density is on the order of three to four times stronger than known dual axial cable designs.) when compared to known dual axial cable designs. This field density is stronger because the area where the charge is distributed is more focused, thereby providing a return path through the drain conductor more effective.

Referring to FIG. 6, a graph of an example resonance shift due to a dual axial cable in accordance with the present invention is shown. By providing a drain conductor which is substantially rectangular an effective current return path is provided through the drain wire. More specifically, the current now returns more through the drain wire and less through the shielded wrap thereby shifting the resonance out of the frequency of interest. Because of the signal conductor and drain conductor orientation and shape, the drain conductor provides a uniform current return path for the signal conductors making the return path through the shield minimal and hence pushing the resonance of the dual axial cable much higher in frequency by almost 6 GHz.

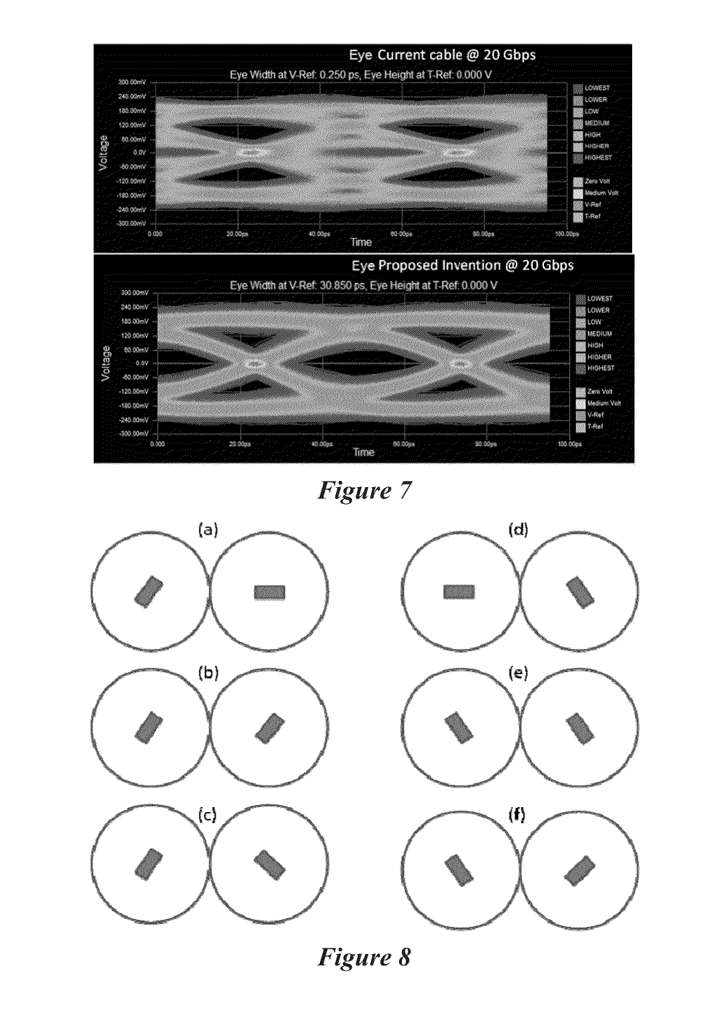

FIG. 7 shows example eye plots comparing a known dual axial cable with a dual axial cable in accordance with the present invention. More specifically, the eye-opening at 20 Gbps speed using a dual axial cable in accordance with the present invention provides advantageous functionality. More specifically, with an open eye along the lines of that shown in FIG. 7, a receiver which is coupled to the dual axial cable can more accurately latch data transmitted via the dual axial cable.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, FIG. 7 shows examples of signal conductor orientations in a dual axial cable in accordance with the present invention. More specifically, by providing signal conductors that are substantially rectangular in shape it is possible to vary the orientation of the signal conductors and thus to vary the electric field resonance of the dual axial cable. The impact of the shift in resonance will vary slightly based on the orientation of the signal conductors and may be optimized for particular applications.

Also in certain embodiments, the cross sectional signal conductor shapes can include rotationally invariant shapes such as a star shape or a triangle shape. The actual cross section shape may be chosen to optimize particular applications.

Consequently, the invention is intended to be limited only by the spirit and scope of the appended claims, giving full cognizance to equivalents in all respects.

What is claimed is:

1. An apparatus for transmitting signals comprising:
a shield;
first and second signal conductors contained within the shield; and
a drain conductor, at least one of the first and second signal conductors and the drain conductor comprising a substantially rectangular cross sectional shape.

2. The apparatus of claim 1, wherein:
first and second signal conductors are configured as a dual axial cable.

3. The apparatus of claim 1, wherein:
the first and second signal conductors are positioned horizontally and vertically equidistant; and
the drain conductor is centrally positioned and vertically offset from the first and second signal conductors.

4. The apparatus of claim 1, wherein:
the first and second signal conductors each comprise a substantially rectangular cross sectional shape.

5. The apparatus of claim 4, wherein:
the first and second signal conductors are oriented such that a top edge of the substantially rectangular cross sectional shape of each conductor are in line.

6. The apparatus of claim 4, wherein:
the first and second signal conductors are oriented such that a top edge of the substantially rectangular cross sectional shape of each conductor are offset.

7. A system comprising:
a processor;
a data bus coupled to the processor;
a plurality of components coupled to the processor via the data bus; and
a cable connecting at least some of the plurality of components within the information handling system, the cable comprising
a shield;
first and second signal conductors contained within the shield; and
a drain conductor, at least one of the first and second signal conductors and the drain conductor comprising a substantially rectangular cross sectional shape.

8. The information handling system of claim 7, wherein:
first and second signal conductors are configured as a dual axial cable.

9. The information handling system of claim 7, wherein:
the first and second signal conductors are positioned horizontally and vertically equidistant; and
the drain conductor is centrally positioned and vertically offset from the first and second signal conductors.

10. The information handling system of claim 7, wherein:
the first and second signal conductors each comprise a substantially rectangular cross sectional shape.

11. The information handling system of claim 10, wherein:
the first and second signal conductors are oriented such that a top edge of the substantially rectangular cross sectional shape of each conductor are in line.

12. The information handling system of claim 10, wherein:
the first and second signal conductors are oriented such that a top edge of the substantially rectangular cross sectional shape of each conductor are offset.
